(19) United States
(12) Patent Application Publication
(10) Pub. No.: US 2017/0138794 A1
(43) Pub. Date: May 18, 2017

(54) RADIATION THERMOMETER, RADIATION TEMPERATURE MEASUREMENT SYSTEM, STORAGE MEDIUM HAVING PROGRAM FOR RADIATION THERMOMETER STORED THEREIN, AND RADIATION TEMPERATURE MEASUREMENT METHOD

(71) Applicants: HORIBA, LTD., Kyoto-shi (JP); HORIBA STEC, CO., LTD., Kyoto-shi (JP)

(72) Inventors: Sho FUJINO, Kyoto (JP); Naoto BANDO, Kyoto (JP); Masakazu MINAMI, Kyoto (JP)

(73) Assignees: HORIBA, LTD., Kyoto-shi (JP); HORIBA STEC, CO., LTD., Kyoto-shi (JP)

(21) Appl. No.: 15/344,848

(22) Filed: Nov. 7, 2016

(30) Foreign Application Priority Data
Nov. 13, 2015 (JP) 2015-223437

(51) Int. Cl. G01J 5/00; G01J 5/10

(52) U.S. Cl. CPC G01J 5/0007; G01J 5/10; G01J 2005/0048

(57) ABSTRACT

In order to provide a radiation thermometer with which a temperature of a measurement object disposed in a chamber configured to form plasma therein can be accurately measured in a noncontact manner from outside of the chamber, the radiation thermometer includes an infrared sensor and a window temperature compensation part. The infrared sensor is disposed outside the chamber configured to form plasma therein, and is configured to detect infrared ray emitted from the measurement object in the chamber through a transmission window provided in the chamber. The infrared sensor is configured to output an output signal according to energy of detected infrared ray. The window temperature compensation part is configured to compensate for a pre-compensation temperature of the measurement object being indicated by the output signal of the infrared sensor, on the basis of a temperature of the transmission window.

### BACKGROUND OF THE INVENTION

Field of the Invention

The present invention relates to a radiation thermometer that detects a temperature of a measurement object in a chamber on the basis of infrared ray emitted from the measurement object.

Background Art

As a parameter having a large influence on, for example, quality of a semiconductor in a semiconductor production equipment, there is a temperature of a substrate in a chamber that is maintained at a high vacuum. In some cases, it may be difficult to directly measure the temperature of the substrate by disposing a thermometer in the chamber. Hence, a radiation thermometer has been used therefor which is configured to measure the temperature of the substrate in the chamber in a noncontact manner by providing a transmission window in the chamber, and detecting infrared ray passing through the transmission window by an infrared sensor disposed outside the chamber (refer to Patent Document 1).

### PRIOR ART DOCUMENT

### Patent Document

Patent Document 1: Japanese Unexamined Patent Publication No. 2015-061930

### SUMMARY OF THE INVENTION

### Problems to be Solved by the Invention

However, in some cases, a semiconductor with desired quality cannot be obtained even by measuring the temperature of the substrate with the radiation thermometer as described above, and by controlling temperature in the chamber.

The present inventors have newly found out the following as a result of wholeheartedly research on the cause of the above problems. That is, when including the step of generating plasma in the chamber, for example, the generation of plasma, heat generation in an RF power source for generating plasma, an instruction to change a setting temperature in a semiconductor manufacturing process recipe, or an operation of a heater or chiller in the chamber causes a temperature change in the chamber and also causes a temperature change in materials constituting the transmission window, such as quartz.

More specifically, this leads to the following finding. That is, calibration of the radiation thermometer is carried out on the assumption that the temperature of the infrared sensor disposed outside the chamber and the temperature of the transmission window are the same. Therefore, when, due to the generation of plasma, the temperature of the transmission window changes and a temperature gradient occurs between the infrared sensor and the transmission window, a measurement error occurs accordingly. Additionally, the temperature gradient between the infrared sensor and the transmission window is not stable and subject to fluctuations due to the influences of the recipe and the power source. This phenomenon also causes a further increase in the measurement error in the radiation thermometer.

The present invention has been made to solve the above problems, and aims at providing a radiation thermometer with which a temperature of a measurement object placed in a chamber configured to form plasma therein is accurately measurable from outside the chamber in a noncontact manner.

### Means of Solving the Problems

Specifically, the radiation thermometer according to the present invention includes an infrared sensor and a window temperature compensation part. The infrared sensor is disposed outside a chamber configured to form plasma therein, so as to be capable of detecting infrared ray emitted from a measurement object in the chamber through a transmission window provided in the chamber. The infrared sensor is configured to output an output signal according to energy of detected infrared ray. The window temperature compensation part is configured to compensate for a pre-compensation temperature of the measurement object being indicated by the output signal of the infrared sensor, on the basis of a temperature of the transmission window.

A radiation temperature measurement method according to the present invention includes the step of disposing an infrared sensor configured to output an output signal according to energy of detected infrared ray so that the infrared sensor is capable of detecting infrared ray emitted from a measurement object in a chamber configured to form plasma therein, through a transmission window provided in the chamber, and the step of compensating for a pre-compensation temperature of the measurement object being indicated by the output signal of the infrared sensor, on the basis of a temperature of the transmission window.

With the above configuration, even when, due to the occurrence of plasma, the temperature in the chamber changes and the temperature of the transmission window also changes, and a temperature gradient is formed between the infrared sensor and the transmission window, the window temperature compensation part compensates for the influence of the temperature gradient with respect to the pre-compensation temperature, thus making it possible to accurately measure the temperature of the measurement object in the noncontact manner.

The present inventors have further found out that the pre-compensation temperature of the measurement object in the chamber to be measured by the radiation thermometer is also affected not only by the temperature of the transmission window but also a concentration or partial pressure of a reactive gas that is introduced into the chamber in order to form plasma. To make it possible to compensate for an error in the pre-compensation temperature due to the concentration of the reactive gas, it is necessary to further include a gas influence compensation part configured to, in a state in which the reactive gas is already introduced into the chamber, compensate for the pre-compensation temperature of the measurement object being indicated by the output signal of the infrared sensor, on the basis of the concentration or partial pressure of the reactive gas.

In some cases, it is, however, difficult to directly measure the concentration or partial pressure of the reactive gas in the chamber by providing a concentration sensor or the like in the chamber, because of constraints imposed on a semiconductor production equipment. In order to solve the above problem and also make it possible to obtain in advance a concentration change of the reactive gas in the chamber so as to compensate for the pre-compensation temperature with higher responsiveness, the concentration or partial pressure of the reactive gas needs to be a value measured in a reactive gas introducing passage being connected to the chamber.

Not only by the concentration of the reactive gas but also a vacuum degree in the chamber has an influence on the pre-compensation temperature. In order to compensate for all of these influences, the gas influence compensation part needs to be configured to compensate for the pre-compensation temperature of the measurement object being indicated by the output signal of the infrared sensor, on the basis of the concentration or partial pressure of the reactive gas, and a pressure in the chamber.

For example, to make it possible to compensate for the pre-compensation temperature even when equipment capable of measuring the concentration or partial pressure of the reactive gas is not provided in advance in the chamber or a passage being in communication with the chamber, such as the reactive gas introducing passage, the radiation thermometer needs to further include a concentration sensor capable of measuring the concentration or partial pressure of the reactive gas.

In order to achieve a more accurate temperature measurement while taking into consideration, for example, attenuation of infrared ray emitted from the measurement object, it is necessary to further include an optical path length compensation part that compensates for the pre-compensation temperature of the measurement object being indicated by an output signal of the infrared sensor, on the basis of an optical path length from the transmission window to the measurement object.

For example, when infrared ray emitted from a substrate is undetectable through a transmission window, there is a need to obtain a sufficient amount of the infrared ray necessary for a temperature measurement from, in place of the substrate, a measurement object other than the substrate in the chamber in order to accurately measure a temperature of the measurement object. For this purpose, the measurement object needs to be made of a material which is different from a material constituting an internal surface of the chamber, and which emits infrared ray in a wavelength range being capable of passing through the transmission window.

In order to obtain an accurate temperature of a measurement object by performing a similar compensation to that of the radiation thermometer according to the present invention, for example, when an existing radiation thermometer is provided in a chamber, it is necessary to install on a computer using a storage medium having a program for a radiation thermometer stored therein. The radiation thermometer includes an infrared sensor being disposed outside a chamber which is configured to form plasma therein and detect infrared ray emitted from a measurement object in the chamber through a transmission window provided in the chamber. The infrared sensor is configured to output an output signal according to energy of detected infrared ray. The storage medium causes the computer to perform a function as a window temperature compensation part to compensate for a pre-compensation temperature of the measurement object being indicated by an output signal of the infrared sensor, on the basis of a temperature of the transmission window. The program for the radiation thermometer may be one which is electronically distributed, or one which is stored in a program storage medium. Examples of the storage medium include a CD, DVD, hard disk, and flash memory.

As a radiation temperature measurement system for accurately measuring a temperature of a measurement object in a chamber in a noncontact manner, there is, for example, one which includes an infrared sensor, a window temperature compensation part, a concentration sensor, and a gas influence compensation part. The infrared sensor is disposed outside a chamber configured to form plasma therein, so as to be capable of detecting infrared ray emitted from a measurement object in the chamber through a transmission window provided in the chamber. The infrared sensor is configured to output an output signal according to energy of detected infrared ray. The window temperature compensation part is configured to compensate for a pre-compensation temperature of the measurement object being indicated by the output signal of the infrared sensor, on the basis of a temperature of the transmission window. The concentration sensor is capable of measuring a concentration or partial pressure of a reactive gas introduced into the chamber. The gas influence compensation part is configured to compensate for the pre-compensation temperature of the measurement object being indicated by an output signal of the infrared sensor, on the basis of the concentration or partial pressure of the reactive gas.

### Effects of the Invention

Thus, the radiation thermometer of the present invention includes the window temperature compensation part configured to compensate for the pre-compensation temperature of the measurement object being indicated by the output signal of the infrared sensor, on the basis of the temperature of the transmission window. Therefore, even when a temperature gradient occurs between the infrared sensor and the transmission window due to the occurrence of plasma in the chamber, the temperature of the measurement object can be accurately measured in the noncontact manner all the time by compensating for the influence of the temperature gradient.

### BRIEF DESCRIPTION OF THE DRAWINGS

FIG. 1 is a schematic diagram that shows a configuration of a radiation thermometer according to one embodiment of the present invention;

FIG. 2 is a functional block diagram that shows the configuration of the radiation thermometer in the embodiment;

FIG. 3 is a schematic graph that shows effects of window temperature compensation according to the embodiment;

FIG. 4 is a schematic diagram that shows a configuration of a radiation thermometer according to another embodiment of the present invention;

FIG. 5 is a schematic graph that shows influence of a vacuum degree on a pre-compensation temperature according to the another embodiment; and

FIG. 6 is a schematic diagram that shows a configuration of a radiation temperature measurement system according to still another embodiment of the present invention.

### DESCRIPTION OF THE EMBODIMENTS

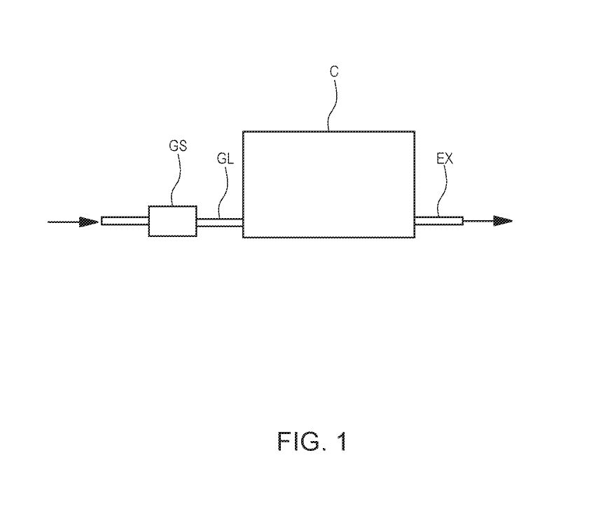

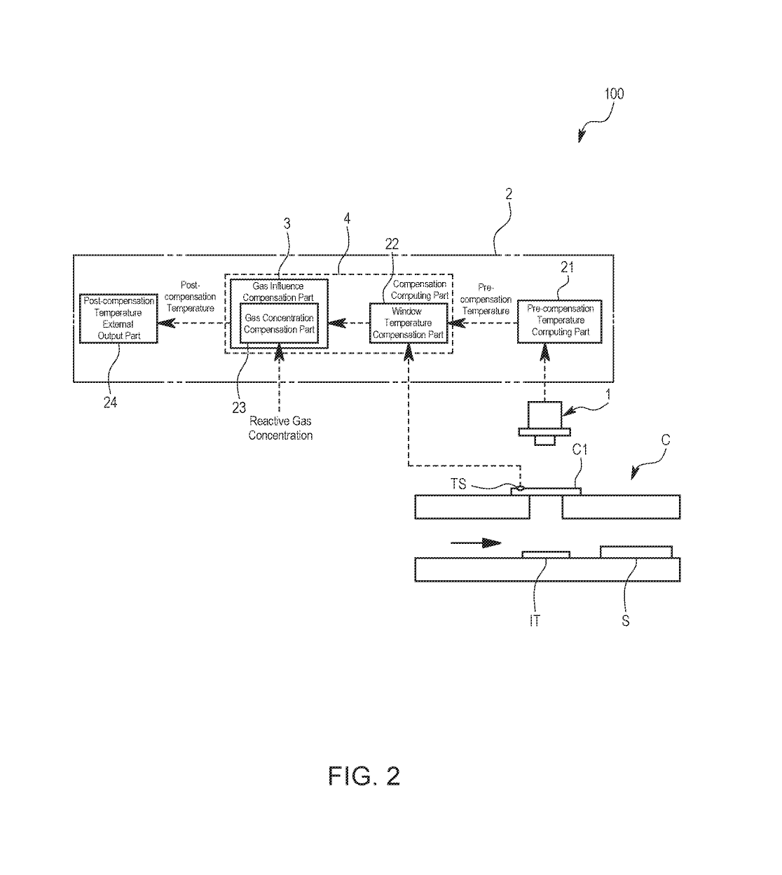

An infrared thermometer (radiation thermometer) 100 according to one embodiment of the present invention is described with reference to FIGS. 1 and 2.

The infrared thermometer 100 of the present embodiment is used, for example, for measuring a temperature of a substrate S placed in a chamber C configured to form plasma therein.

A reactive gas introducing passage GL, through which a reactive gas for forming plasma in the chamber C, is connected to the chamber C as shown in FIG. 1. An exhaust mechanism EX for maintaining the interior of the chamber C at a predetermined vacuum degree is also connected to the chamber C. The chamber C is configured to carry out deposition therein by generating plasma on a surface of the substrate S.

The reactive gas passing through the reactive gas introducing passage GL is one in which a liquid material, such as trimethyl gallium (Ga(CH₃)₃), is gasified by bubbling with an inert carrier gas, such as helium. In other words, the reactive gas is a mixed gas of a component gas obtainable by gasifying trimethyl gallium, and the carrier gas. Control is carried out so that the concentration of the composition gas in the mixed gas is maintained at a predetermined concentration.

The reactive gas introducing passage GL is provided with a concentration sensor GS in order to control the concentration of the reactive gas, namely, the concentration of the composition gas in the mixed gas. The concentration sensor GS employs, for example, NDIR method, and is configured to measure the concentration of the reactive gas in a noncontact manner. Alternatively, the concentration sensor GS may be, for example, one which is configured to measure a total pressure of the reactive gas and a partial pressure of the composition gas, and then compute a concentration from proportions of the measured total pressure and partial pressure.

The chamber C includes, as shown in FIG. 2, an external wall body to form an internal space, and a transmission window C1 disposed so as to close a part of the external wall body which is penetratedly formed. The internal space accommodates therein the substrate S as an object on which deposition is to be carried out. Separately from the substrate S, the internal space further accommodates therein, for example, a ceramics IT that is a material having capability of emitting infrared ray according to a temperature and having high emissivity. The ceramics IT is disposed so as to face the transmission window C1. The ceramics IT is made of a material different from a material constituting an internal surface of the chamber C. A temperature of the ceramics IT is recognizable as having approximately the same temperature as the substrate S whose temperature is actually desired to check.

The transmission window C1 is made of a special glass composed of, for example, barium fluoride (BaF₂), and is configured to transmit, for example, 80% or more of the infrared ray emitted from the ceramics IT in a predetermined wavelength range. The transmission window C1 further includes, as a temperature sensor TS, for example, a thermocouple attached to an external surface of the transmission window C1.

Details of the infrared thermometer 100 of the present embodiment are described below with reference to FIGS. 1 and 2.

The infrared thermometer 100 is made up of the infrared sensor 1 disposed outside the chamber C, and a computing mechanism 2 that computes a temperature of the ceramics IT as the measurement object placed in the chamber C, on the basis of outputs respectively from the infrared sensor 1, the temperature sensor TS, and the concentration sensor GS.

As shown in FIG. 2, the infrared sensor 1 is disposed in alignment with the transmission window C1 and the ceramics IT as the measurement object so that the infrared sensor 1 is capable of detecting infrared ray emitted from the ceramics IT on the outside of the chamber C. The infrared sensor 1 outputs, as a voltage, an output signal according to energy of detected infrared ray.

The computing mechanism 2 is a so-called computer or arithmetic circuit including, for example, a CPU, memory, an AD/DA convertor, input/output means, and display means. The computing mechanism 2 is configured to perform at least functions as a pre-compensation temperature computing part 21, a window temperature compensation part 22, a gas influence compensation part 3, a post-compensation temperature external output part 24 as shown in FIG. 2 by causing a program for the infrared thermometer (radiation thermometer) stored in the memory to be executed to cause cooperation among various kinds of devices.

These parts are described below in detail.

The pre-compensation temperature computing part 21 performs a conversion from the output of the infrared sensor 1 to a temperature of the ceramics IT as the measurement object, and then outputs the temperature as a pre-compensation temperature. The pre-compensation temperature is a temperature under the same measurement condition as during calibration in the infrared thermometer 100. Therefore, when, due to the formation of plasma in the chamber C, the temperature of the transmission window C1 increases and a temperature gradient occurs between the infrared sensor 1 and the transmission window C1, this results in an error from an actual temperature of the ceramics IT. The pre-compensation temperature is also subject to an error due to the influence of the vacuum degree in the chamber C and the influence of the concentration of the reactive gas being introduced into the chamber C. The influence of the temperature of the transmission window C1, the influence of the vacuum degree, and the influence of the concentration of the reactive gas on the pre-compensation temperature may be handled as occurring independently or mutually interfering with one another. In the present embodiment, these parameters are handled as independently affecting the pre-compensation temperature, and their respective influences are handled as being independently compensatable.

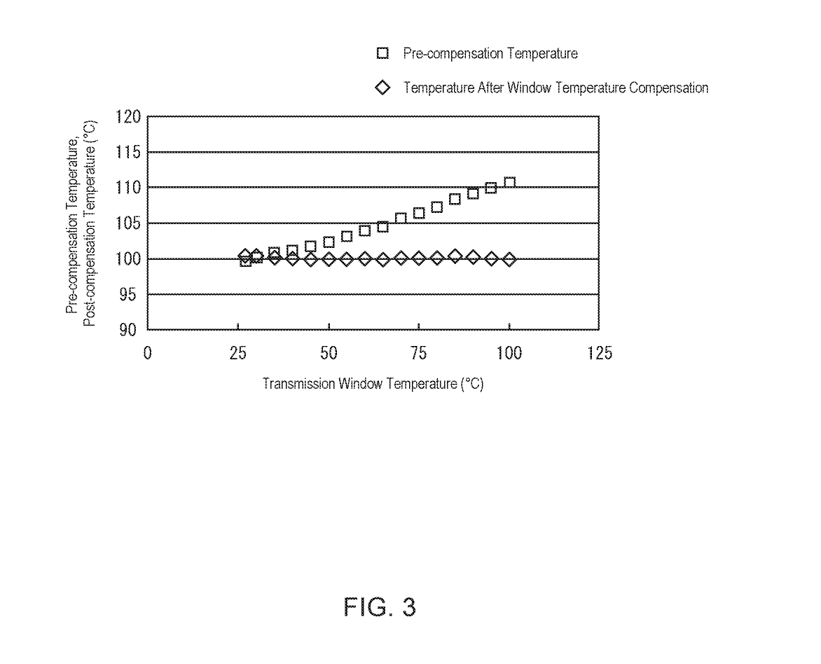

The window temperature compensation part 22 is configured to compensate for the pre-compensation temperature of the ceramics IT being indicated by the output signal of the infrared sensor 1, on the basis of the temperature of the transmission window C1. More specifically, as shown in the graph in FIG. 3, when only a window temperature is changed while the temperature of the measurement object is maintained at 100° C. and the vacuum degree in the chamber C and the concentration of the reactive gas are maintained constant at a predetermined value, an indication value of the pre-compensation temperature increases with increasing temperature of the transmission window C1, and deviates from 100° C. that is the actual temperature of the ceramics IT. In the present embodiment, a transmission window temperature-error relationship, which is a relationship between the temperature of the transmission window C1 and an error between the pre-compensation temperature and the actual temperature, is prepared in advance by an experiment or the like, and is stored in the window temperature compensation part 22. The transmission window temperature-error relationship may be an approximate equation on the basis of, for example, experimental data, or may be created as a table. Alternatively, the pre-compensation temperature may be compensated according to the window temperature on the basis of a theoretical formula without conducting the experiment. In other words, temperature compensation may be performed on the basis of parameters, such as an emissivity of the ceramics IT as the measurement object, an infrared transmission spectrum of the transmission window C1, a setting emissivity being set to the infrared thermometer 100, and the pre-compensation temperature to be outputted from the infrared sensor 1, and Planck's Law. In the present embodiment, the window temperature compensation part 22 computes an error being currently generated due to a temperature change of the transmission window C1 from a current temperature of the transmission window C1 to be measured by the temperature sensor TS, and from the transmission window temperature-error relationship. The window temperature compensation part 22 is configured to perform compensation by subtracting the error from the pre-compensation temperature. By performing this compensation, a temperature after compensating for the window temperature as shown in the graph in FIG. 3 indicates a temperature close to the actual temperature of the ceramics IT.

The gas influence compensation part 3 is configured to compensate for the pre-compensation temperature of the ceramics IT as the measurement object, which is indicated by the output signal of the infrared sensor 1, on the basis of the concentration of the reactive gas. The description that the gas influence compensation part 3 compensates for the pre-compensation temperature denotes further performing compensation after the window temperature compensation part 22 compensates for the pre-compensation temperature in the present embodiment. This is a concept containing that the gas influence compensation part 3 performs compensation before the window temperature compensation part 22 compensates for the pre-compensation temperature.

The gas influence compensation part 3 includes a gas concentration compensation part 23 to compensate for the pre-compensation temperature on the basis of the concentration of the reactive gas in the present embodiment.

The gas concentration compensation part 23 is configured to compensate for the pre-compensation temperature on the basis of the concentration of the reactive gas to be measured by the concentration sensor GS disposed in the reactive gas introducing passage GL. In other words, the infrared thermometer 100 of the present embodiment has a data acquisition part to acquire an output of the concentration sensor GS that is existing equipment, and the gas concentration compensation part 23 is configured to compensate for the pre-compensation temperature on the basis of the acquired output. This configuration makes it possible to perform temperature compensation using, for example, the output of the concentration sensor GS that is already disposed for controlling the concentration of the reactive gas. This eliminates the need to newly add expensive equipment, such as an NDIR, only for the purpose of the temperature compensation, thereby considerably reducing installation costs for the infrared thermometer 100. The gas concentration compensation part 23 is also configured to perform compensation by using the concentration of the reactive gas before the occurrence of plasma in an upstream of the chamber C, instead of using the concentration of the reactive gas directly measured in the chamber C. It is therefore possible to compensate for the pre-compensation temperature by using, for example, a value indicated by the existing concentration sensor GS disposed to control bubbling. This eliminates the need to separately dispose a concentration sensor GS in a semiconductor production equipment. Further, because the compensation for the pre-compensation temperature is performed using the concentration of the reactive gas before the occurrence of plasma, a response rate for compensation can be increased as in a kind of feedforward control.

The compensation for the pre-compensation temperature by the gas concentration compensation part 23 is described in detail below. The pre-compensation temperature has a higher value relative to the actual temperature of the ceramics IT when the concentration of the reactive gas decreases in a state in which the temperature of the transmission window C1 is maintained constant while maintaining the vacuum degree constant. The reason for this is as follows. Because the reactive gas existing between the ceramics IT and the transmission window C1 becomes thin, an infrared adsorption rate is lowered, and a larger amount of energy than that during calibration is detected. In order to compensate for this type of error, a concentration-error relationship, which is a relationship between the concentration of the reactive gas and an error between the pre-compensation temperature and the actual temperature of the ceramics IT, is obtained in advance by an experiment or the like in the present embodiment. The concentration-error relationship may be an approximate equation or table using these as parameters. Alternatively, the temperature compensation on the basis of the concentration of the reactive gas may be performed on the basis of a theoretical formula without conducting the experiment. For example, when the kinds of the reactive gas and an infrared adsorption coefficient to be determined according to the kind thereof are known, it is also possible to compensate for the pre-compensation temperature on the basis of the concentration of the reactive gas to be measured and Beer-Lambert law. In the present embodiment, the gas concentration compensation part 23 computes a currently generating error due to a concentration change of the reactive gas, on the basis of a current concentration of the reactive gas obtainable from the concentration sensor GS, and the concentration-error relationship. The gas concentration compensation part 23 performs compensation by subtracting the computed error from the pre-compensation temperature.

Thus, the window temperature compensation part 22 and the gas influence compensation part 3 are configured to function as a compensation computing part 4 configured to compensate for the pre-compensation temperature computed only according to the voltage outputted from the infrared sensor 1, and configured to output a post-compensation temperature.

The post-compensation temperature external output part 24 is configured to externally output the post-compensation temperature to be outputted from the compensation computing part 4 with respect to display means, such as a display or LCD, or is configured to externally output the post-compensation temperature to, for example, a concentration control unit to control the concentration of the reactive gas. Thus, the post-compensation temperature is externally outputted so that the temperature of the ceramics IT is used for display or control as the temperature of the substrate S.

The infrared thermometer 100 so configured according to the present embodiment provides the accurate post-compensation temperature obtainable by compensating for the error due to the temperature change of the transmission window C1 and the error due to the concentration change of the reactive gas, which are contained in the pre-compensation temperature converted only from the output signal of the infrared sensor 1.

Accordingly, the temperature of the substrate S in the chamber C is obtainable in the noncontact manner and in exact value. It is therefore possible to accurately control, for example, the concentration and inflow of the reactive gas on the basis of the temperature. Consequently, a plasma generation state in the chamber C is continuously maintainable in a desired state.

This makes it possible to reduce quality variation of the substrate S deposited in the chamber C, and also retain a high quality state thereof over a long term, thereby further improving yield in a semiconductor manufacturing than conventional ones.

Furthermore, the infrared thermometer 100 according to the present embodiment eliminates the need to separately dispose various kinds of sensors for checking the state of the interior of the chamber C. Therefore, without the need for a considerable facility change with respect to an internal structure of the existing chamber C, the temperature of the substrate S accommodated therein is accurately measured only by externally disposing the temperature sensor TS, thus leading to improved yield of the semiconductor process.

Additionally, the infrared sensor 1 is disposed to detect the infrared ray emitted from the ceramics IT instead of detecting the infrared ray emitted from the substrate S. Hence, for example, even when the substrate S is made of a material less liable to emit infrared ray, it is possible to accurately measure the temperature thereof. It is also possible to dispose the transmission window C1 at a location except for a major region where plasma occurs, for example, a peripheral part in the chamber C. Consequently, the formation of plasma and the deposition process are less susceptible to adverse effects.

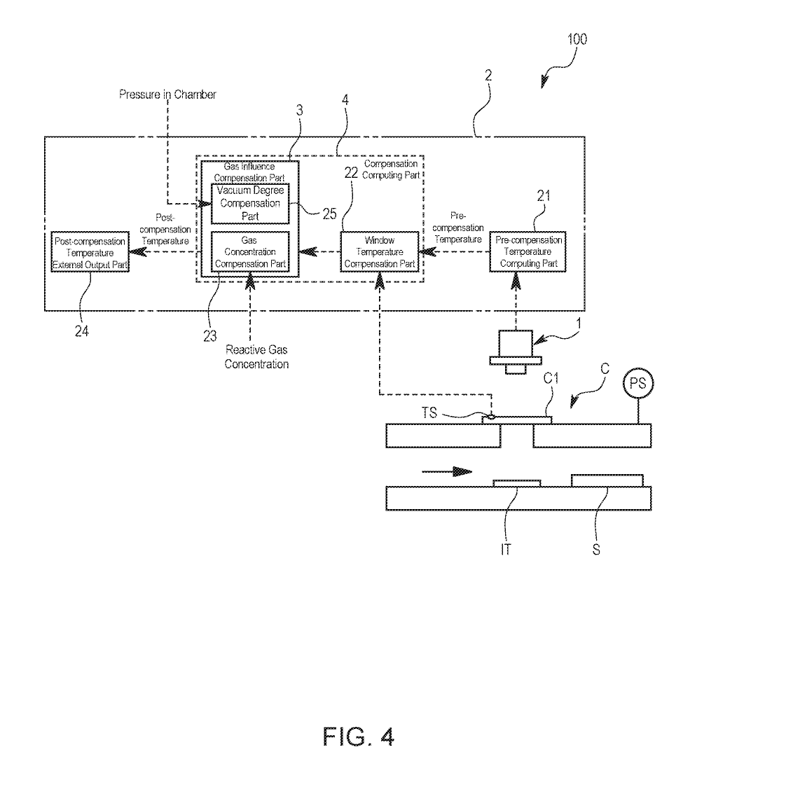

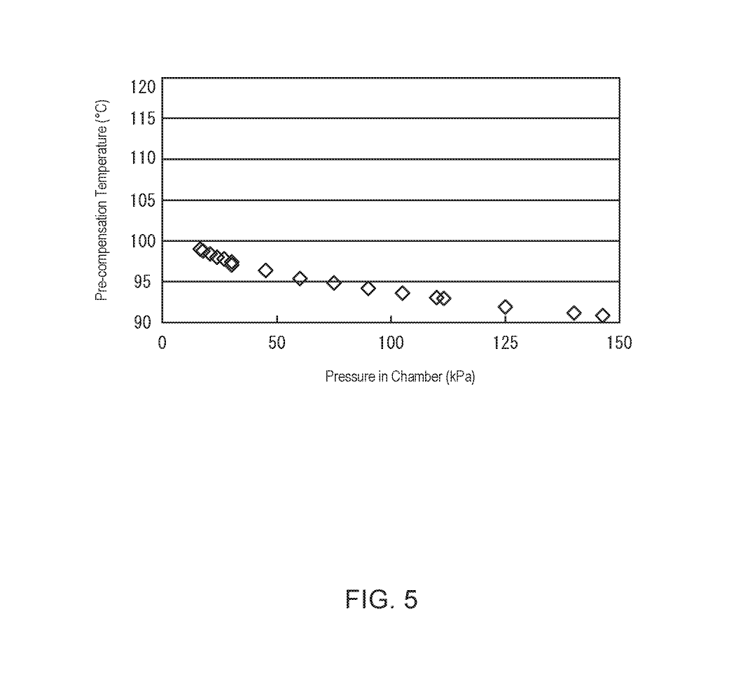

Another embodiment is described below with reference to FIGS. 4 and 5. Components common to the foregoing embodiment are labeled with the same reference numerals.

With an infrared thermometer 100 according to the present embodiment, the gas influence compensation part 3 is configured to compensate for a pre-compensation temperature on the basis of not only a concentration of a reactive gas but also a vacuum degree in the chamber C.

In other words, a gas influence compensation part 3 is made up of the gas concentration compensation part 23 and a vacuum degree compensation part 25 as shown in FIG. 4.

The vacuum degree compensation part 25 is configured to compensate for the pre-compensation temperature on the basis of, for example, an output from a pressure sensor PS that is disposed in the chamber C in order to measure a pressure therein. More specifically, when the vacuum degree is lowered by increasing the pressure in the chamber C in a state in which the concentration of the reactive gas is maintained constant while the temperature of the ceramics IT and the temperature of the transmission window C1 are maintained constant, the pre-compensation temperature to be converted only by an output from the infrared sensor 1 has a lower value relative to an actual temperature with increasing pressure, as indicated on the graph in FIG. 5. The reason for this is as follows. Increasing pressure in the chamber C increases the number of atoms or molecules that come into contact with and adsorb the infrared ray emitted from the ceramics IT, and decreases the amount of the infrared ray that reaches the infrared sensor 1.

Therefore, in the present embodiment, a pressure-error relationship, which is a relationship between a pressure in the chamber C and an error between a pre-compensation temperature and an actual temperature of the ceramics IT, is obtained in advance by an experiment or the like. The pressure-error relationship is stored in the vacuum degree compensation part 25. Alternatively, without carrying out the experiment, the pre-compensation temperature may be compensated according to Beer-Lambert law by using a measured value only in terms of pressure while handling the type of a reactive gas, an absorption coefficient of the gas, and a concentration of the gas as known values, which are regarded as being constant without being changed from a supply bomb. In the present embodiment, the vacuum degree compensation part 25 compensates for the pre-compensation temperature by computing an error between the pre-compensation temperature and the actual temperature of the ceramics IT on the basis of a current pressure in the chamber C to be measured by the pressure sensor PS, and the pressure-error relationship, and then subtracting the error from the pre-compensation temperature.

Thus, with the infrared thermometer 100 according to the present embodiment, a more accurate post-compensation temperature is obtainable by compensating for the pre-compensation temperature according to the temperature of the transmission window C1, the concentration of the reactive gas, and the vacuum degree in the chamber C.

Other embodiments are described below.

The present invention may be configured as a radiation temperature measurement system including, besides the infrared sensor, a temperature sensor for measuring the temperature of the transmission window, a concentration sensor, a pressure sensor, or the like. In other words, when neither an existing concentration sensor nor a pressure sensor is disposed in a chamber or facility attached thereto, they may be newly provided therein and configured to compensate for an output of the infrared sensor on the basis of outputs of these sensors.

The infrared thermometer of the present invention needs to include at least the window temperature compensation part, and needs to be configured to compensate for the pre-compensation temperature according to the temperature of the transmission window. Alternatively, the compensation computing part may include only the window temperature compensation part and the vacuum degree compensation part.

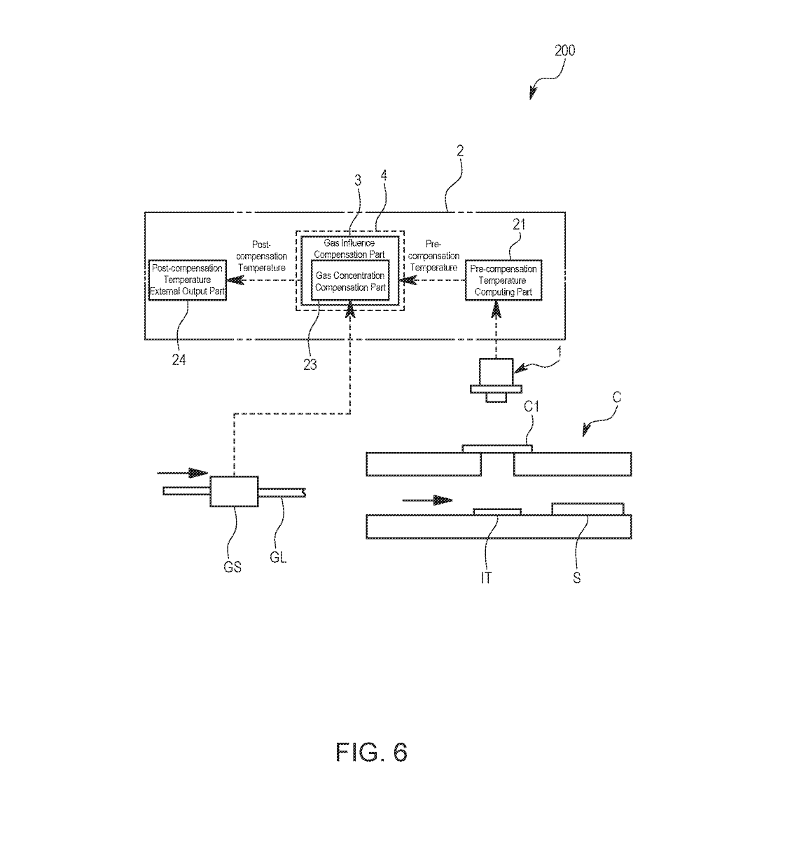

Still alternatively, the pre-compensation temperature may be compensated on the basis of the concentration or partial pressure of the reactive gas without performing window temperature compensation. For example, the present invention may be a radiation temperature measurement system including an infrared sensor, a concentration sensor, and a gas influence compensation part. The infrared sensor is disposed outside a chamber configured to form plasma therein so as to be capable of detecting infrared ray emitted from a measurement object in the chamber through the transmission window provided in the chamber. The infrared sensor is configured to output an output signal according to energy of detected infrared ray. The concentration sensor is capable of measuring a concentration or partial pressure of a reactive gas introduced into the chamber. The gas influence compensation part is configured to compensate for a pre-compensation temperature of the measurement object being indicated by the output signal of the infrared sensor, on the basis of the concentration or partial pressure of the reactive gas. More specifically, as shown in FIG. 6, the radiation temperature measurement system 200 may include the infrared sensor 1 and the concentration sensor GS, and the gas influence compensation part 4 whose function is implemented by the computing mechanism 2 may be configured to compensate for the pre-compensation temperature outputted from the infrared sensor 1 on the basis of a concentration measured by the concentration sensor GS.

The gas influence compensation part may be configured to compensate for the pre-compensation temperature only with the partial pressure of the reactive gas without using the concentration of the reactive gas. Even with this configuration, an accurate temperature is obtainable because the concentration and partial pressure of the reactive gas are approximately the same.

The location of the concentration sensor is not limited to the reactive gas introducing passage, and it may be in the chamber or an exhaust passage from the chamber.

When the pre-compensation temperature is compensated on the basis of a plurality of parameters, it is preferable to further include an interference compensation part to perform interference compensation in consideration of interferences of these parameters.

The infrared thermometer needs to include, for example, the infrared sensor as hardware, the pre-compensation temperature computing part as software, and the window temperature compensation part. In the absence of sensors for performing various kinds of compensations in the facility of an existing chamber for which the infrared thermometer is used, the concentration sensor and the pressure sensor may be retrofitted.

The measurement object is not limited to the ceramics, and may be any one capable of emitting infrared ray. Alternatively, the measurement object may be the substrate.

The compensation computing part may further include an optical path length compensation part configured to compensate for a pre-compensation temperature of the measurement object being indicated by an output signal of the infrared sensor, on the basis of an optical path length from the transmission window to the measurement object.

The concentration sensor may be disposed, for example, in an exhaust passage or on an exhaust structure through which gas is exhausted from the chamber, instead of being disposed on the reactive gas introducing passage. This makes it possible to obtain a concentration of the reactive gas after plasma is generated in the chamber, thereby performing temperature compensation that more strictly reflects the state in the chamber.

Although in the foregoing embodiment, the value obtainable after the pre-compensation temperature computing part performs temperature conversion from a voltage output signal of the infrared sensor is compensated according to the temperature of the transmission window, the gas concentration, the pressure, or the like, the window temperature compensation part, the gas influence compensation part, and the vacuum degree compensation part may be configured to perform compensation for a voltage outputted from the infrared sensor in order to obtain a post-compensation temperature. With this configuration, the compensation is performed in a state before the temperature conversion from the voltage signal, and therefore, the compensation is performable before occurrence of a rounding error due to the temperature conversion. It is therefore possible to make the post-compensation temperature further approach a true value.

Other than above, various modifications and combinations of embodiments may be made without departing from the spirit and scope of the present invention.

### DESCRIPTION OF THE REFERENCE NUMERAL

200 radiation temperature measurement system
100 infrared thermometer (radiation thermometer)
1 infrared sensor
2 computing mechanism
21 pre-compensation temperature computing part
22 window temperature compensation part
23 gas concentration compensation part
24 post-compensation temperature external output part
25 vacuum degree compensation part
3 gas influence compensation part
4 compensation computing part
C chamber
C1 transmission window
GL reactive gas introducing passage
GS concentration sensor
TS temperature sensor
PS pressure sensor
EX exhaust passage

What is claimed is:

1. A radiation thermometer comprising:
an infrared sensor disposed outside a chamber configured to form plasma therein, so as to be capable of detecting infrared ray emitted from a measurement object in the chamber through a transmission window provided in the chamber, the infrared sensor being configured to output an output signal according to energy of detected infrared ray; and
a window temperature compensation part configured to compensate for a pre-compensation temperature of the measurement object being indicated by the output signal of the infrared sensor, on a basis of a temperature of the transmission window.

2. The radiation thermometer according to claim 1,
wherein a reactive gas is introduced into the chamber, and
wherein the radiation thermometer further comprises a gas influence compensation part to compensate for a pre-compensation temperature of the measurement object being indicated by the output signal of the infrared sensor, on a basis of a concentration or partial pressure of the reactive gas.

3. The radiation thermometer according to claim 2, wherein the concentration or partial pressure of the reactive gas is a value measured in a reactive gas introducing passage being connected to the chamber.

4. The radiation thermometer according to claim 2, wherein the gas influence compensation part is configured to compensate for the pre-compensation temperature of the measurement object being indicated by the output signal of the infrared sensor, on a basis of the concentration or partial pressure of the reactive gas and a pressure in the chamber.

5. The radiation thermometer according to claim 2, further comprising a concentration sensor capable of measuring the concentration or partial pressure of the reactive gas.

6. The radiation thermometer according to claim 1, further comprising an optical path length compensation part configured to compensate for the pre-compensation temperature of the measurement object being indicated by the output signal of the infrared sensor, on a basis of an optical path length from the transmission window to the measurement object.

7. The radiation thermometer according to claim 1, wherein the measurement object is made of a material which is different from a material constituting an internal surface of the chamber and which emits infrared ray in a wavelength range being capable of passing through the transmission window.

8. A storage medium having a program for a radiation thermometer stored therein, the infrared sensor being disposed outside a chamber configured to form plasma therein, so as to be capable of detecting infrared ray emitted from a measurement object in the chamber through a transmission window provided in the chamber, the infrared sensor being configured to output an output signal according to energy of detected infrared ray,
wherein the storage medium causes a computer to perform a function as a window temperature compensation part configured to compensate for a pre-compensation temperature of the measurement object being indicated by an output signal of the infrared sensor, on a basis of a temperature of the transmission window.

9. A radiation temperature measurement system comprising:
an infrared sensor being disposed outside a chamber configured to form plasma therein, so as to be capable of detecting infrared ray emitted from a measurement object in the chamber through a transmission window provided in the chamber, the infrared sensor being configured to output an output signal according to energy of detected infrared ray;
a window temperature compensation part configured to compensate for a pre-compensation temperature of the measurement object being indicated by the output signal of the infrared sensor, on a basis of a temperature of the transmission window;
a concentration sensor capable of measuring a concentration or partial pressure of a reactive gas introduced into the chamber; and
a gas influence compensation part configured to compensate for the pre-compensation temperature of the measurement object being indicated by an output signal of the infrared sensor, on a basis of a concentration or partial pressure of the reactive gas.

10. A radiation temperature measurement method comprising:
disposing an infrared sensor configured to output an output signal according to energy of detected infrared ray, outside a chamber configured to form plasma therein, so as to be capable of detecting infrared ray emitted from a measurement object in the chamber, through a transmission window provided in the chamber; and
compensating for a pre-compensation temperature of the measurement object being indicated by the output signal of the infrared sensor, on a basis of a temperature of the transmission window.
